(19) United States
(12) Patent Application Publication
(10) Pub. No.: US 2019/0266526 A1
(43) Pub. Date: Aug. 29, 2019

(54) MULTI-DIMENSIONAL ORGANIZATION OF DATA FOR EFFICIENT ANALYSIS

(71) Applicant: WOLTERS KLUWER FINANCIAL SERVICES, INC., Minneapolis, MN (US)

(72) Inventors: Colleen Knuff, New York, NY (US); Riz Noorani, New York, NY (US); Andrew Broughton, New York, NY (US); Jennifer Esterheld, New York, NY (US); Lina M. Herrera, New York, NY (US); Richard Myott, New York, NY (US); David Christopher Patton, New York, NY (US); John C. Gagnon, New York, NY (US); Steven Calise, New York, NY (US)

(21) Appl. No.: 15/906,641

(22) Filed: Feb. 27, 2018

(51) Int. Cl. G06Q 10/06; G06F 7/02

(52) U.S. Cl. CPC G06Q 10/0635; G06F 7/02

(57) ABSTRACT

Systems and methods are provided for generating numerical values indicative of risk factors across multiple dimensions in an organization. A first hierarchy of auditable entities in an organization are generated using a first parameter, and a second hierarchy of auditable entities in the same organization are generated using a second parameter. The first hierarchy and the second hierarchy correspond to a first dimension and a second dimension of the organization, respectively. An indication of a risk factor and a numerical score for the risk factor are received. Additionally, selections of a first auditable entity in the first hierarchy and a second auditable entity in the second hierarchy, with which the risk factor is to be associated, are received. In response to the received selections, respective risk scores for the first auditable entity and the second auditable entity are automatically calculated using the received numerical score for the risk factor.

### FIELD OF THE DISCLOSURE

This application generally relates to database organization and management techniques and, more particularly, organizing data to efficiently generate numerical values indicative of risk factors across multiple dimensions in an organization.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Efficiency and convenience of using database-driven applications depends to a large extent on how data is organized in the databases. For example, data describing various parameters of an organization can be organized according to numerous schemes, some more efficient than others. As a more particular example, a database can store information necessary for calculating risk factors for a business organization, with multiple various variables contributing to the risk factors at different levels of the organization.

In general, Identifying and managing such forms of risk is critical to achieving business goals of any organization. The existing approaches to quantifying risk factors to generate numerical scores are limited in terms of efficiency and accuracy. For example, a business organization can be viewed from various “vantage points,” or along different “dimensions” (legal entities that make up the organization can define one dimension, geographic locations where the organization is present can define another dimension, etc.). The existing techniques do not provide an efficient mechanism for managing risk in the context of multiple dimensions.

### SUMMARY

In one aspect, a computer-implemented method is provided for generating numerical values indicative of risk factors across multiple dimensions in an organization. The method comprises generating, by one or more processors, a first hierarchy of auditable entities in an organization using a first parameter and second hierarchy of auditable entities in the same organization using a second parameter, the first hierarchy and the second hierarchy corresponding to a first dimension of the organization and a second dimension of the organization, respectively. The method further comprises receiving, by the one or more processors, an indication of a risk factor and a numerical score for the risk factor, receiving, by the one or more processors via a user interface, selections of a first auditable entity in the first hierarchy and a second auditable entity in the second hierarchy, with which the risk factor is to be associated, and automatically calculating, by the one or more processors, respective risk scores for the first auditable entity and the second auditable entity using the received numerical score for the risk factor, in response to the received selections.

In some implementations, the method above also can include providing an input field for specifying the risk factor and the numerical score, and providing an interactive control for specifying a plurality of entities in two or more hierarchies, with which the risk factor is to be associated, and associating the indicated risk factor and the numerical score of the risk factor with the plurality of entities in two or more hierarchies in response to a single instance of the interactive control being actuated.

Further, in some implementations, the method above can include generating a first and second data records describing the risk factor, generating a data record describing the first auditable entity, generating a data record describing the second auditable entity, and generating respective data records to indicate an association between the risk factor and each of the first and second auditable entities. In this manner, the method eliminates the need to create extra data records, thereby improving the efficiency of using memory as well as the efficiency of calculating aggregate risk by “walking” up each tree. Further, the method eliminates the need to duplicate user input.

Still further, the method above in some implementations includes automatically traversing, for each hierarchy, a corresponding data structure, calculating a cumulate risk along the path of traversal, and displaying the cumulate risk for at least some of the nodes of the tree along the path of traversal. In this manner, the method allows rolled-up risk to be calculated more efficiently. In particular, because the roll-up is automatically done for several dimensions, these techniques reduce the number of operations required to generate a multi-dimensional risk assessment model.

In another aspect, a computer system for generating numerical values indicative of risk factors across multiple dimensions in an organization is provided. The computer system includes one or more processors and one or more memories. The memories store instructions that, when executed by the one or more processors, cause the computer system to: generate a first hierarchy of auditable entities in an organization using a first parameter and second hierarchy of auditable entities in the same organization using a second parameter, the first hierarchy and the second hierarchy corresponding to a first dimension of the organization and a second dimension of the organization. The instructions further cause the computer system to receive an indication of a risk factor and a numerical score for the risk factor, receive, via a user interface, selections of a first auditable entity in the first hierarchy and a second auditable entity in the second hierarchy, with which the risk factor is to be associated, and automatically calculate respective risk scores for the first auditable entity and the second auditable entity using the received numerical score for the risk factor, in response to the received selections.

The features, functions, and advantages that have been discussed can be achieved independently in various embodiments or may be combined in yet other embodiments further details of which can be seen with reference to the following description and drawings.

### BRIEF SUMMARY OF THE DRAWINGS

FIG. 1 schematically illustrates one example approach to assigning risk in an organization in which entities can be organized along multiple dimensions;

FIG. 2 illustrates an example computing environment in which the techniques of this disclosure can be implemented to generate numerical values indicative of risk factors across multiple dimensions in an organization;

FIGS. 3A and 3B illustrate exemplary primary and secondary dimensions of an example organization;

FIG. 3C illustrates exemplary risk factors associated with auditable entities within one dimension of an organization;

FIG. 3D illustrates an exemplary risk factor associated with multiple auditable entities in different dimensions of an organization;

FIGS. 4A-4C illustrate example user interfaces for generating numerical values indicative of risk factors across multiple dimensions in an organization;

FIG. 5 illustrates an example method for generating numerical values indicative of risk factors across multiple dimensions in an organization, which can be implemented in the computing environment of FIG. 2; and

FIG. 6 illustrates an example organization of data in the database of the system of FIG. 2.

### DESCRIPTION

Generally speaking, the techniques of this disclosure reduce the number of operations required to propagate certain changes through a dataset. These techniques are discussed below with reference to a system that generates a multi-dimensional model for scoring and aggregating risk. In an example configuration, multiple hierarchical relationships of auditable entities are defined for an organization using parameters of the auditable entities. The hierarchical relationships can correspond to respective dimensions, and the auditable entities can include departments, programs, activities, locations, functions, initiatives, etc. Each auditable entity can include certain parameters such as location, relation to other business units, etc.

An operator can define and modify these dimensions via the user interface exposed by the system. The operator can for example define nodes (e.g., node “A”=accounting department at the company headquarters), relationships between these nodes (e.g., node A is a child of node B as well as a child of node C), dimensions along which entities can be organized, etc. The resulting data structure can include a directed graph, where a parent node can have multiple child nodes, and where a child node can have multiple parent nodes. The data structure allows the system to efficiently aggregate risk along a specified dimension. For example, the system can calculate the risk associated with a certain node N based on the sum of respective risk scores assigned to the child nodes of N, for each of which the risk scores in turn can be calculated based on the respective child nodes.

The operator further can operate the user interface to define auditable elements. When an auditable element (e.g., strategic risk, operation risk, fraud risk) is created, a user can specify a risk factor and a numerical score for the risk factor. For example, a user can specify a numerical score for fraud risk. The score can include one or several numerical components, e.g., inherent risk and residual risk. Furthermore, the user can specify an association of the auditable element with auditable entities in multiple dimensions. For example, the user then can indicate that the fraud risk is associated with auditable entities in both an organizational dimension and a geographic dimension, e.g., a payroll auditable entity in the organizational dimension, and a United States auditable entity in a geographic dimension. According to the defined hierarchical relationships of the auditable entities in each dimension, the system then calculates a final score for each entity where risks are identified. Accordingly, the system can use the relationships to efficiently calculate risk scores for entities at various levels of the respective hierarchy, in multiple dimensions, without requiring that the user specify the same auditable element for each dimension. In addition to allowing users to view, report, and aggregate risk scores along various dimensions, the system can subsequently display historical data related to risk scores for various entities, along a single dimension or multiple dimensions.

When calculating an aggregate score, the system also can account for entity-specific variables that affect the score risk for the entity. For example, the system can account for the revenue level or the number of years since the area was last audited, which are measures that could increase the entity level of risk besides the aggregated score coming from the risks related to the entity.

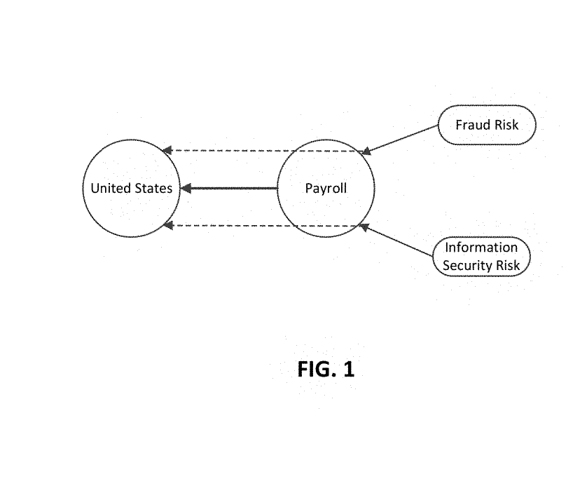

According to one possible approach to quantifying risk in an organization, an entity in one dimension of the organization can be associated with an entity in another dimension, and risk factors assigned to one entity can be automatically associated with the other entity. For example, risk factors such as, e.g., fraud risk and information security risk, are assigned to the payroll entity and are automatically propagated to a geographic entity, such as, e.g., the United States. This approach is schematically illustrated in FIG. 1.

However, this approach yields incorrect assessment of risk when, for instance, risk factors associated with business units are not equally applicable to all geographic locations. For instance, the United States entity may actually be associated with fraud risk but not information security risk. Yet because both are associated with payroll risk, the information security risk is wrongly attributed to the United States in the prior art approach.

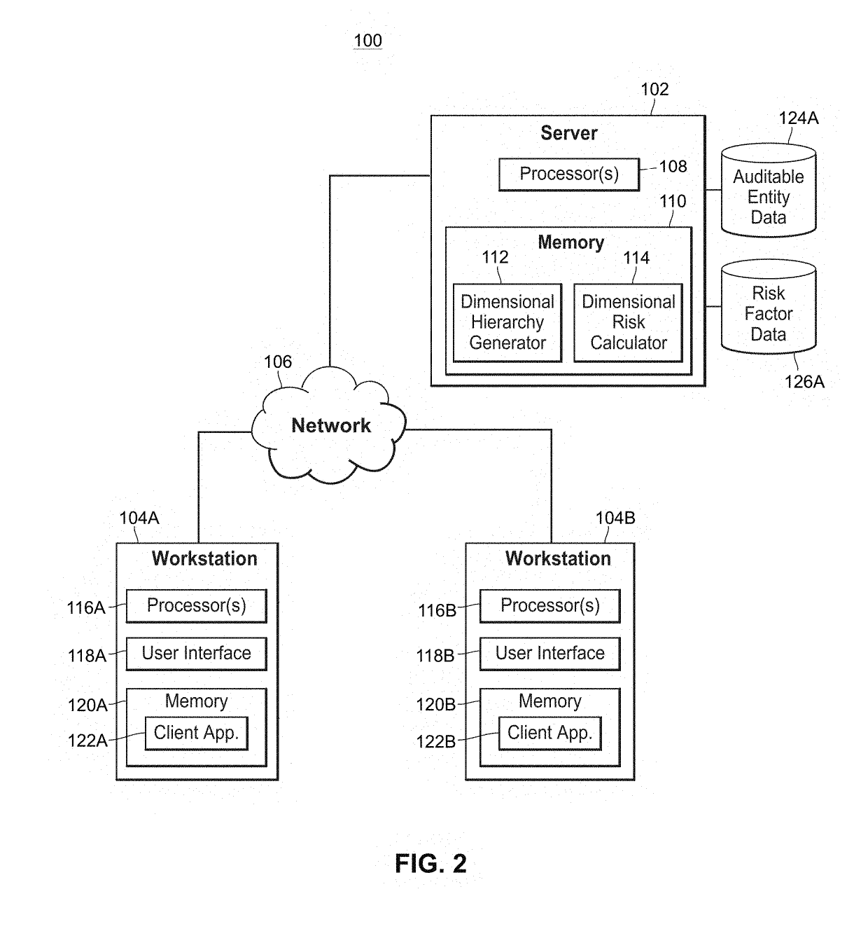

Referring now to FIG. 2, an example computing environment 100 in which the techniques of this disclosure can be implemented is illustrated. The computing environment 100 can include a server system 102, which various computing devices, such as workstations 104A and 1046, can access via a communication network 106 (e.g., the Internet.) The server system 102 includes one or more processors 108, which can include CPUs, GPUs, etc., and a non-transitory memory 110 readable by the one or more processors 108. The memory 110 can store instructions that implement a dimensional hierarchy generator 112 as well as a dimensional risk calculator 114.

The server system 102 can access an auditable entity database 124 store auditable entity data for an organization as well as a risk factor database 126 to store risk factor data for the organization. The databases 124 and 126 in general can reside on any suitable computing device(s) which the server 12 can access directly or via the network 106. The data to be stored in the databases 124 and 126 can be input by users at the client workstations 104A and 1046, for example, or uploaded from these client workstations.

Each of the workstations 104A and 1046 can include one or more processors (116A and 116B, respectively), a user interface (118A and 1186, respectively) which can include any suitable input and output devices via which a user of one of the workstations can input, for example, auditable entity data as well as risk factor data to be transmitted to the server 102. The workstations 104A and 1046 further include a memory (120A and 1206, respectively) readable by the one or more processors 116A, 1166. The memory 120A, 1206 can store a client application (122A and 122B, respectively) via which a user of one of the workstations can access the dimensional hierarchy generator 112 and/or the dimensional risk calculator 114. The client application 122A, 122B can be a web browser, for example, or a special-purpose software application.

In operation of the system illustrated in FIG. 2, the dimensional hierarchy generator 112 generates data structures describing multiple hierarchies of auditable entities in an organization, with each hierarchy corresponding to a respective dimension of the organization. The auditable entities can include departments, programs, activities, locations, functions, initiatives, etc., while the dimensions of the auditable entities can include for example a legal entities dimension, a business unit dimension, a geographic dimension, an organizational process dimension, an informational technology (IT) system dimension, an enterprise risk management system, one or several dimensions corresponding to standards set by various professional associations, committees, standards bodies, etc., or any other suitable dimension of the organization.

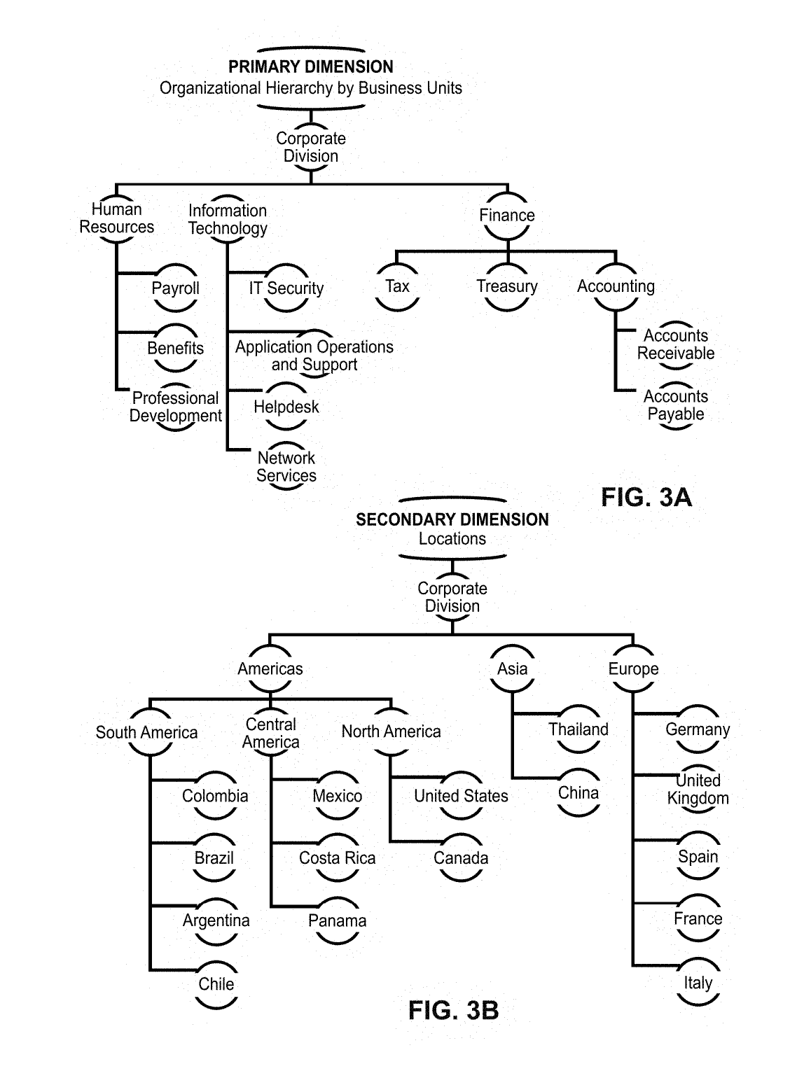

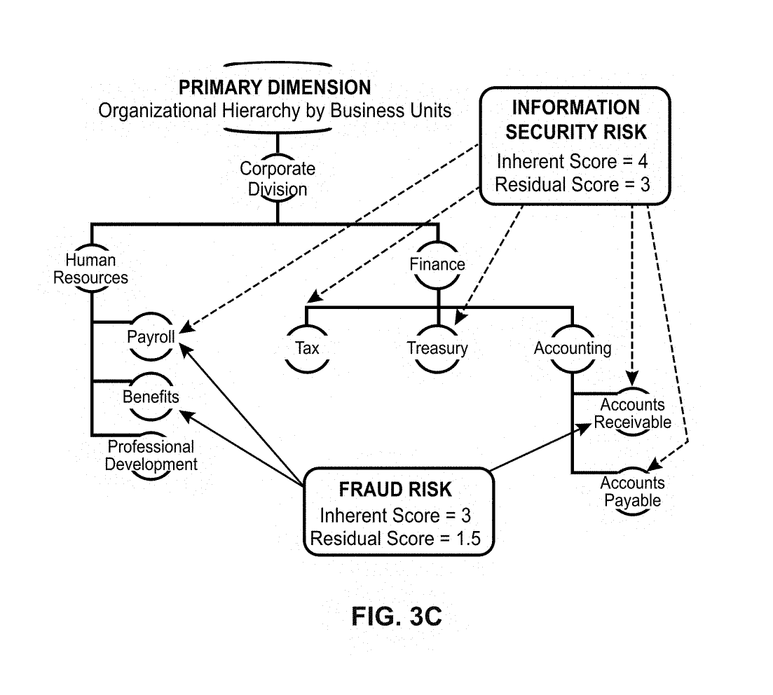

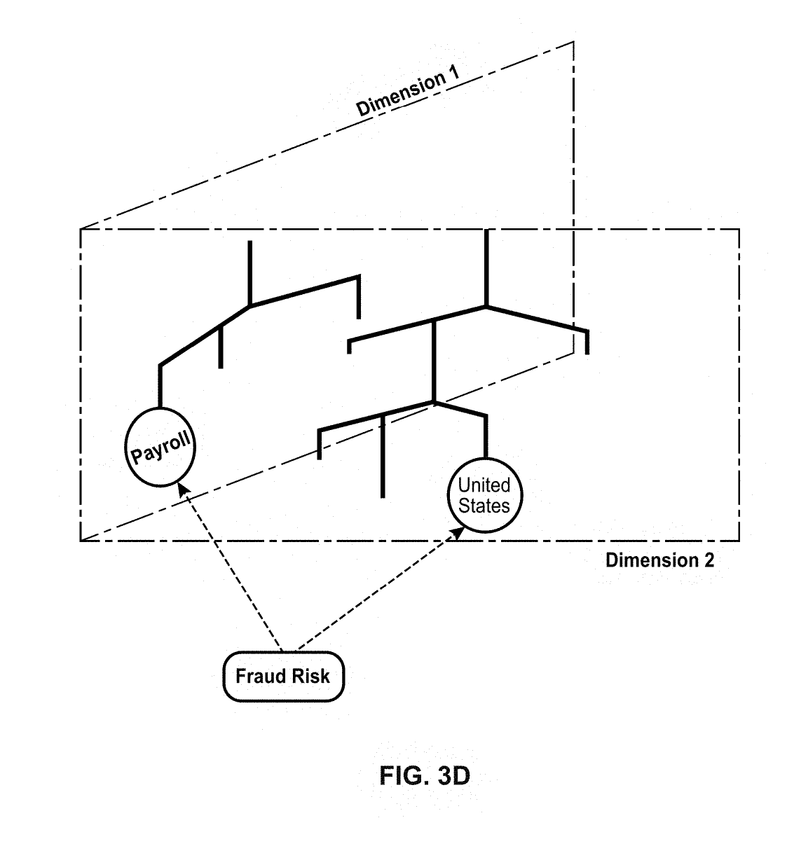

FIGS. 3A and 3B illustrate exemplary data structures that describe first and second dimensions of the same organization. As shown in FIG. 3A, for instance, a first dimension of the organization is an organizational hierarchy by business units. For instance, corporate division is a “parent” auditable entity in the organizational hierarchy, with “child” auditable entities such as human resources, information technology, and finance. Further, the human resources auditable entity is in turn a parent auditable entity for lower-level child auditable entities in the organizational hierarchy such as payroll, benefits, and professional development. Similarly, the information technology auditable entity is in turn a parent auditable entity for lower-level child auditable entities in the organizational hierarchy such as IT security, application operations and support, helpdesk, and network services, etc., as shown in FIG. 3A. Accordingly, in this example any risks associated with IT security, application operations and support, helpdesk, and/or network services will propagate up the organizational hierarchy to information technology. Similarly, in this example, any risks associated with human resources, information technology, and/or finance will propagate up the organizational hierarchy to the corporate division auditable entity.

As shown in FIG. 3B, for example, a second dimension of the same organization is a location hierarchy. For example, as in the organizational hierarchy, the corporate division is also a parent auditable entity in the location hierarchy. In the location hierarchy, however, the child auditable entities of the corporate division auditable entity include location-based child auditable entities such as the Americas, Asia, and Europe. Additionally, the Americas auditable entity is in turn a parent of lower-level child auditable entities in the location hierarchy such as South America, Central America, and North America. Similarly, the Asia auditable entity is in turn a parent of lower-level child auditable entities in the location hierarchy such as Thailand and China, and so on, as shown in FIG. 3B.

Moreover, referring back to FIG. 2 the dimensional risk calculator 114 can calculate respective risk scores for multiple different auditable entities in different dimensions of the same organization. The dimensional risk calculator 114 receives an indication of a risk factor and a numerical score for the risk factor (which may include one or several numerical components, e.g., inherent risk and residual risk), as well as auditable entities with which the risk factor is to be associated, e.g., via the user interface 118A, 118B. Advantageously, a user can specify multiple auditable elements along with associations of these auditable elements with multiple dimensions, without having to specify the same auditable element for each dimension. That is, the auditable entities with each a given risk factor is to be associated can include auditable entities in multiple dimensions. Using the received numerical score for the risk factor, and in response to the received selections, the dimensional risk calculator 114 automatically calculates respective risk scores for each auditable entity. Accordingly, the dimensional risk calculator 114 can efficiently calculate risk scores for entities at various levels of the respective hierarchy, for each dimension.

FIG. 3C illustrates risk factors associated with multiple auditable entities in the same dimension, while FIG. 3D illustrates a risk factor associated with multiple auditable entities in different dimensions. Referring now to FIG. 3C, an information security risk factor is associated with payroll, tax, treasury, accounts receivable, and accounts payable auditable entities in the organizational hierarchy. Additionally, a fraud risk factor is associated with the benefits, payroll, and accounts receivable auditable entities in the organizational hierarchy. Accordingly, the dimensional risk calculator 114 calculates the risk score associated with each auditable entity based on the risk factor and numerical scores and the hierarchical relationships. For instance, to calculate the risk score for the human resources auditable entity, the dimensional risk calculator 114 includes the fraud risk associated with the payroll and the benefits auditable entities, as well as the information security risk associated with the payroll auditable entity.

Turning to FIG. 3D, the fraud risk factor associated with the payroll auditable entity in the organizational dimension (as shown in FIG. 3C) is further associated with a United States auditable entity in the location dimension. Accordingly, the dimensional risk calculator 114 calculates the risk score for the North America auditable entity in the location hierarchy (as shown in FIG. 3B) using the fraud risk factor associated with the United States auditable entity.

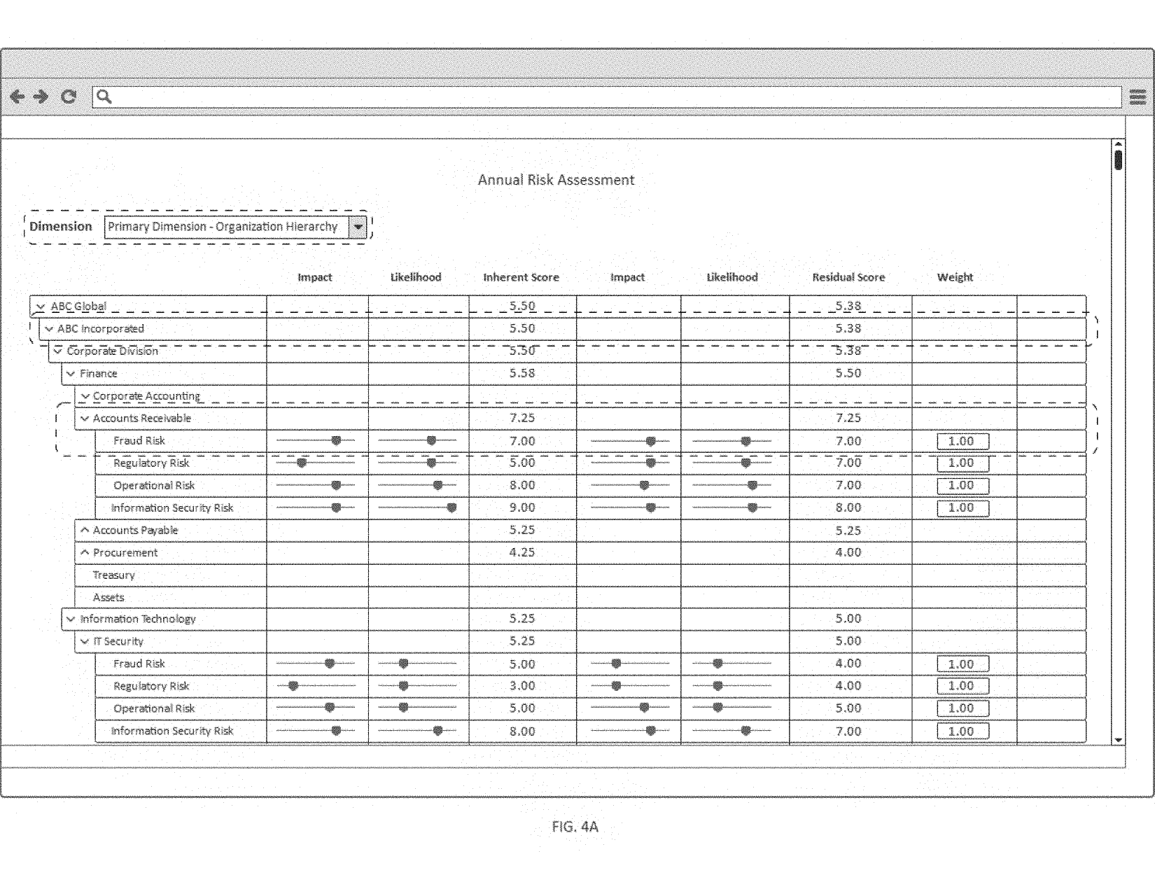

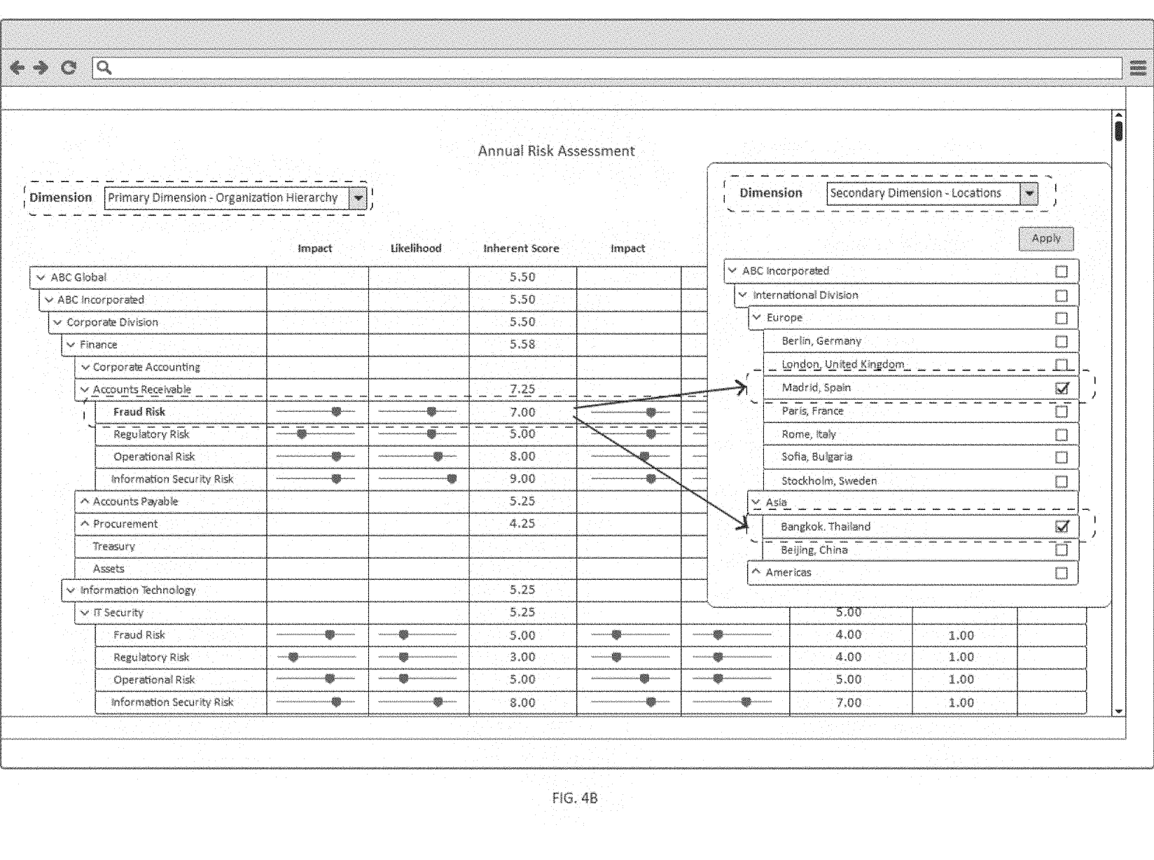

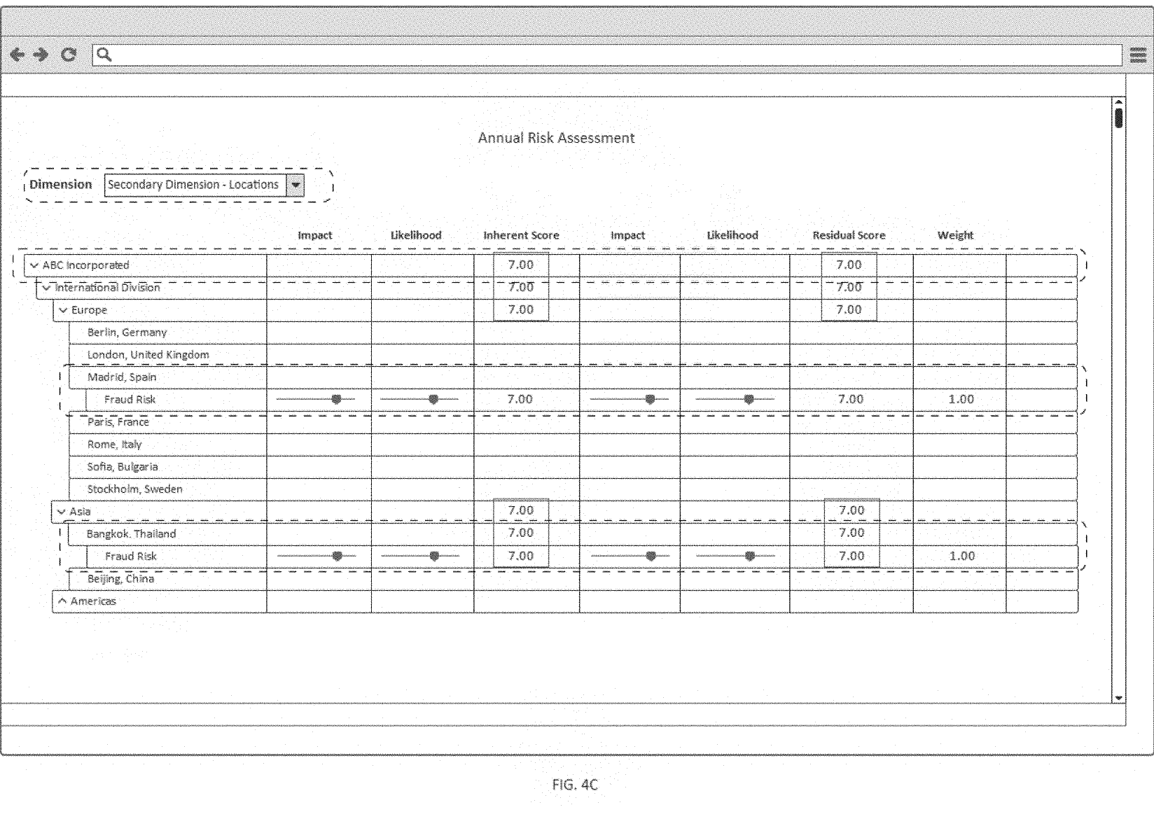

FIG. 4A-C illustrate example user interfaces for generating numerical values indicative of risk factors across multiple dimensions in an organization, e.g., for a primary dimension and a secondary dimension.

Generally speaking, the system can score each strategic risk in the primary dimension and display these strategic risks in a read-only format in the secondary dimension. The system then performs a rollup, or aggregation, of risk factors into each secondary dimension, within the context of a particular assessment. The system can traverse the tree to identify ancestors in a particular dimension and add risk factors to the corresponding scores. The system can perform the same rollup in multiple dimensions, for different ancestries in different dimensions.

For instance, as shown in FIG. 4A, when an organizational hierarchy dimension is selected by a user, the user interface displays a parent corporate division auditable entity, with child auditable entities such as finance and information technology. The organizational hierarchy dimension in this example can be the primary dimension. Furthermore, the user interface displays a finance auditable entity as a parent of additional lower-level child auditable entities such as corporate accounting, accounts receivable, accounts payable, procurement, treasury, and assets. Specifically, a fraud risk factor with a numerical value of 7.00 is displayed as associated with the accounts receivable auditable entity. Using the user interface, a user may modify the fraud risk factor, i.e., change the numerical value of the fraud risk. The fraud risk factor, as well as the regulatory/legal risk factor, operational risk factor, and information security risk factor that are also associated with the accounts receivable auditable entity, is used by the system to automatically calculate a numerical value indicative of the risk factor associated with the accounts receivable auditable entity. As shown in the user interface of FIG. 4A, the numerical value indicative of the risk factor associated with the accounts receivable auditable entity is 7.25. Moreover, the system uses the risk factor associated with the accounts receivable auditable entity (as well as risk factors associated with corporate accounting, accounts payable, procurement, treasury, and assets) to calculate an inherent risk factor of 5.58 for the parent finance auditable entity, as shown in the user interface.

Turning now to FIG. 4B, the user interface allows a user to assign an existing risk factor associated with auditable entity in one dimension to auditable entities in additional dimensions. That is, as shown in FIG. 4B, the user has selected the fraud risk factor that is already associated with the accounts receivable auditable entity in the organizational dimension. The user has further selected, using a dimension assignment tool, a location dimension. Accordingly, the user may select auditable entities within the location dimension, such as Bangkok, Thailand, and Madrid, Spain, with which the fraud risk factor is to be associated.

Referring now to FIG. 4C, the fraud risk factor of 7.00 associated with the accounts receivable auditable entity in the organizational dimension shown in FIGS. 4A and 4B is now additionally associated with the Bangkok, Thailand and Madrid, Spain auditable entities in the location dimension. Furthermore, the fraud risk factor is used to automatically calculate the numerical value indicative of risk associated with Asia, the parent auditable entity of the Bangkok, Thailand auditable entity, as well as Europe, the parent auditable entity of the Madrid, Spain auditable entity, and these numerical values are displayed for the user in the user interface.

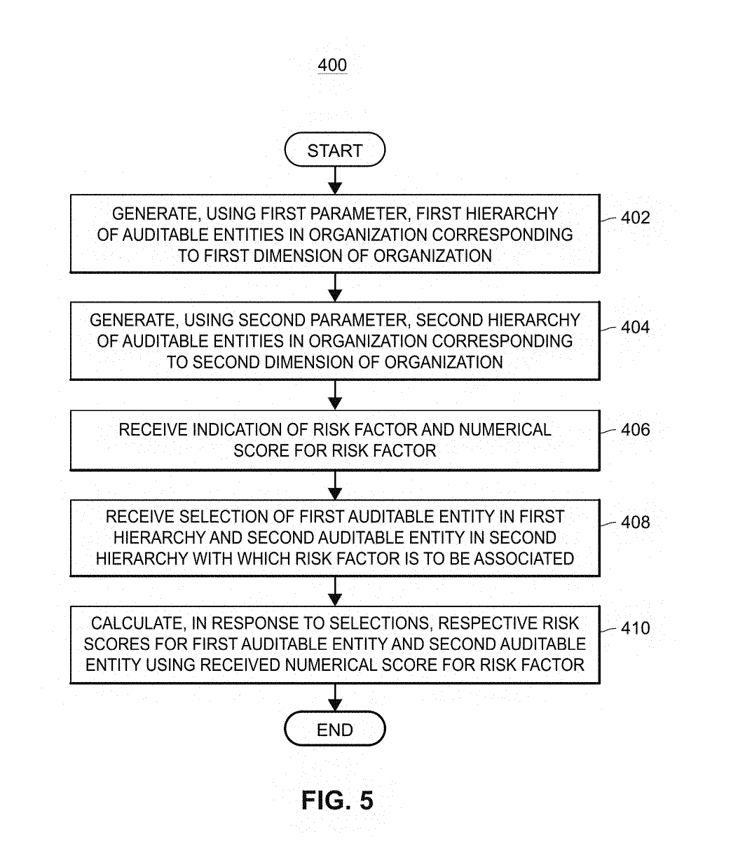

FIG. 5 illustrates an example method 400 for generating numerical values indicative of risk factors across multiple dimensions in an organization, which can be implemented a set of instructions stored on a computer-readable memory and executable on one or more processors of a suitable computing system, e.g., in the computing environment 100.

At block 402, using a first parameter, a first hierarchy of auditable entities in an organization is generated. The first hierarchy of auditable entities corresponds to a first dimension of an organization. In one example, the first dimension is a geographic dimension in which the organization is made up of a plurality of geographic locations. In this example, each geographic location is an auditable entity. For example, a country (e.g., the United States) may be an auditable entity. The country may be a parent auditable entity, with “child” auditable entities including states (e.g., Illinois) within the country. A state auditable entity may in turn have child auditable entities including cities (e.g., Chicago) within each state. In another example, the first dimension is a legal entities dimension in which the organization is made up of a plurality of legal entities. In this example, each legal entity is an auditable entity. In still another example, the first dimension is an organization process dimension in which the organization is made up of a plurality of organizational processes or organizational units. In this example, each organizational process or unit is an auditable entity. As discussed above, other examples of dimensions include a business unit dimension, an IT system dimension, a geographic dimension, etc.

At block 404, using a second parameter, a second hierarchy of auditable entities in the same organization is generated. The second hierarchy of auditable entities corresponds to a second dimension in the organization. Generally speaking, the second dimension is different from the first dimension. For instance, if the first dimension is a legal entities dimension, the second dimension may be a geographic dimension or an organization process dimension, or any other suitable second dimension.

At block 406, an indication of a risk factor and a numerical score for the risk factor are received. In some examples, a second risk factor, and a numerical score for the second risk factor are received as well, or any number of risk factors with numerical scores for each are received. In some instances, the numerical score for the risk factor includes both an inherent risk score and a residual risk score. Additionally, in some instances, the numerical score for the risk factor is a scaled rating (e.g., a risk score on a scale of 1-10).

At block 408, a selection of a first auditable entity in the first hierarchy, and a selection of a second auditable entity in the second hierarchy, with which the risk factor is to be associated, are received (e.g., via user interface 118A, 118B). While one risk factor may be associated with both the first auditable entity and the second auditable entities, other risk factors may be associated with only one of the first auditable entity and the second auditable entity.

At block 410, in response to the received selections, respective risk scores for the first auditable entity and the second auditable entity are automatically calculated using the received numerical score for the risk factor. In many instances, the risk score for the first auditable entity may be different from the risk score for the second auditable entity, because a different combination of risk factors may be associated with each.

Moreover, in some examples the method further includes automatically calculating a risk score for an auditable entity in a parent relationship with the first auditable entity in the first hierarchy, based on the received risk factor and the numerical score. For example, a risk score for a parent United States auditable entity in a geographic dimension may be calculated using the numerical score for a risk factor associated with a child Illinois auditable entity. Similarly, in some examples, the method further includes automatically calculating a risk score for an auditable entity in a parent relationship with the second auditable entity in the second hierarchy, based on the received risk factor and the numerical score.

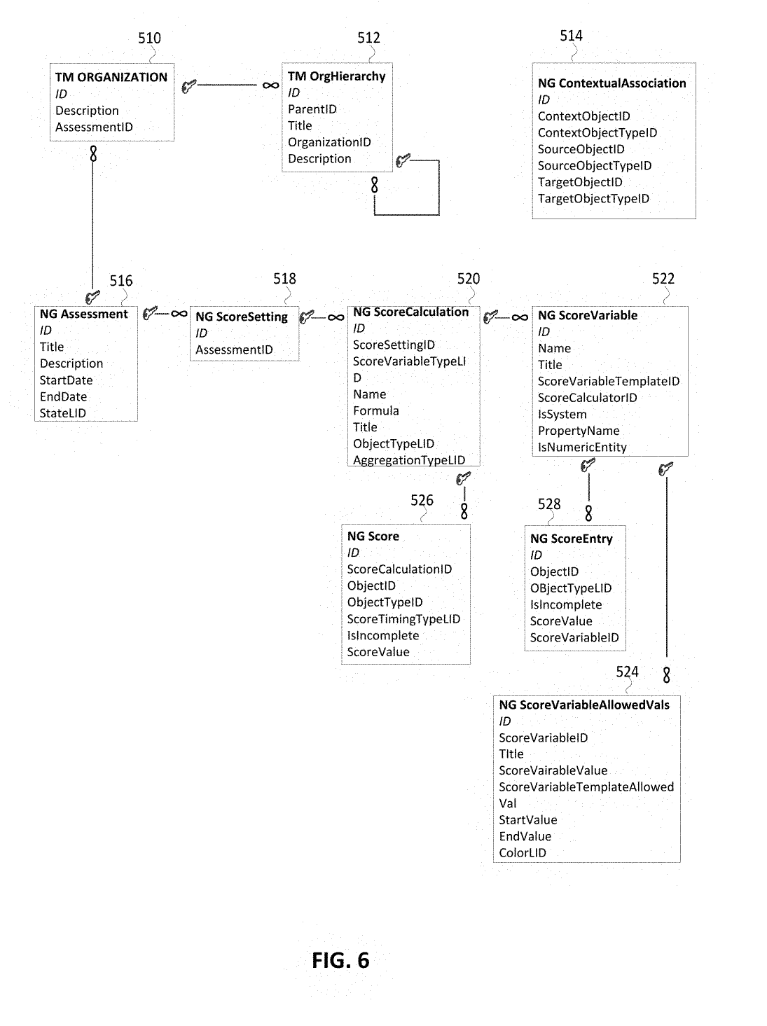

For further clarity, example implementation of a database is discussed next with reference to FIG. 6. In FIG. 6, the key symbol identifies the primary key column. For example, each record in the table 510 describes an organization and stores an identifier that serves as the primary key. The infinity symbol indicates a one-to-many relationship between a certain record and the table next to which infinity symbol is placed. Thus, according to FIG. 6, each record in the table 510 can be associated with multiple records in the database 512. More specifically, each record in the table 512 includes a field Organization Identifier which unambiguously identifies a certain record in the table 510.

A table 516 can store assessments for various organizations. Each assessment can correspond to a separate record and refer to a respective tree of objects. The top of the tree can be stored in a separate table (not shown) globally defining dimensions. Descriptions of dimensions can be stored in the table 510, and descriptions of individual nodes (corresponding to respective entities) can be stored in the table 512. Each assessment can have a primary dimension and any suitable number (e.g., zero, one, two, four) of secondary dimensions. An operator can create objects to be tracked for entities in the primary dimensions and assign these objects to entities in the secondary dimensions. These associations can be stored in a table 514.

More particularly, after an operator assigns a risk factor to an entity in the primary dimension, he or she can assign this risk to an entity in another dimension. Referring to FIG. 6, the operator can assign the risk to one or more entities via the user interface. In response to the assigning request, the system can create a new record in the table 514, which stores contextual associations. For example, the data structure for a certain organization can include node “sales” in the primary dimension corresponding to the corporate structure, and node “expenses” in the secondary dimension corresponding to accounts. The operator can define a risk factor corresponding to “kickbacks,” assign a numeric score to the risk factor, and assign this risk fact to both “sales” and “expenses.”

Using the data structure discussed above, the system can first score each strategic risk in the primary dimension (e.g., Organization Hierarchy). The system then can automatically roll up these scores, or aggregate the scores in accordance with the relationships defined by the data structure. With continued reference to FIG. 6, a table 518 can store scoring information linked by Assessment Identifier to a respective assessment. A record in the table 516 can store score settings to control the scoring saved in the table 518. Further, a table 520 can store formulas (e.g., X+Y, X*0.5+Y*0.3, X*Y) used when calculating scores. A table 522 can store variables used by the formulas (e.g., X, Y), and a table 524 can stores a list of allowed values for a given variable. Still further, tables 526 and 528 can store the calculated scores and score variable entries referenced back to objects, respectively.

In the system discussed above, the score for each object can be stored in a database record only once, even though the score can be used in multiple dimensions. Because entities in the secondary dimension are distinct from entities in the primary dimension, there is no need for a database entry storing a score to also store dimensions to which the score applies. In an example simplified scenario, the database stores data that describes the structure of an organization in terms of two dimensions. In the first (primary) dimension, the organization includes a corporate entity defining the top node, with three child nodes for the sales, payroll, and IT entities, respectively. In the second (secondary) dimension, the organization includes the Atlantic Accounts entity defining the top node, with two child nodes for expenses and income, respectively. The operator defines a “kickbacks” risk in the primary dimension, associating this risk with the sales entity, and assigns this risk to the expenses entity in the secondary dimension.

After rolling up the risk in multiple dimensions, the database in this example can store the following data:

| Assessment Title | Object Title | Object Type | Score | Score Type |
|---|---|---|---|---|
| Two-dimensional | Kickbacks | Strategic Risk | 5 | Inherent |
| assessment | | | | |
| Two-dimensional | Kickbacks | Strategic Risk | 3 | Residual |
| assessment | | | | |
| Two-dimensional | Corporate | Entity | 5 | Inherent |
| assessment | | | | |
| Two-dimensional | Corporate | Entity | 3 | Residual |
| assessment | | | | |
| Two-dimensional | Sales | Entity | 5 | Inherent |
| assessment | | | | |
| Two-dimensional | Sales | Entity | 3 | Residual |
| assessment | | | | |
| Two-dimensional | Atlantic | Entity | 5 | Inherent |
| assessment | Accounts | | | |
| Two-dimensional | Atlantic | Entity | 3 | Residual |
| assessment | Accounts | | | |
| Two-dimensional | Expenses | Entity | 5 | Inherent |
| assessment | | | | |
| Two-dimensional | Expenses | Entity | 3 | Residual |
| assessment | | | | |

### Additional Considerations

The following additional considerations apply to the foregoing discussion. Throughout this specification, plural instances may implement functions, components, operations, or structures described as a single instance. Although individual functions and instructions of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

For example, the network may include, but is not limited to, any combination of a LAN, a MAN, a WAN, a mobile, a wired or wireless network, a private network, or a virtual private network. Moreover, it is understood that any number of client computers or display devices are supported and may be in communication with the workstations 104A, 1046.

Additionally, certain embodiments are described herein as including logic or a number of functions, components, modules, blocks, or mechanisms. Functions may constitute either software modules (e.g., non-transitory code stored on a tangible machine-readable storage medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

Accordingly, the term hardware should be understood to encompass a tangible entity, which may be one of an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules may provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and may operate on a resource (e.g., a collection of information).

The various operations of exemplary functions and methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or functions described herein may be at least partially processor-implemented. For example, at least some of the functions of a method may be performed by one or more processors or processor-implemented hardware modules. The performance of certain of the functions may be distributed among the one or more processors, not only residing within a single machine, but deployed across a number of machines. In some exemplary embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the functions may be performed by a group of computers (as examples of machines including processors). These operations are accessible via a network (e.g., the Internet) and via one or more appropriate interfaces (e.g., application program interfaces (APIs)).

The performance of certain operations may be distributed among the one or more processors, not only residing within a single machine, but deployed across a number of machines. In some exemplary embodiments, the one or more processors or processor-implemented modules may be located in a single geographic location (e.g., within a home environment, an office environment, or a server farm). In other exemplary embodiments, the one or more processors or processor-implemented modules may be distributed across a number of geographic locations.

Some portions of this specification are presented in terms of algorithms or symbolic representations of operations on data and data structures stored as bits or binary digital signals within a machine memory (e.g., a computer memory). These algorithms or symbolic representations are examples of techniques used by those of ordinary skill in the data processing arts to convey the substance of their work to others skilled in the art. As used herein, a “function” or an “algorithm” or a “routine” is a self-consistent sequence of operations or similar processing leading to a desired result. In this context, functions, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a function, process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a computer system 100 for purposes of illustration only. One of ordinary skill in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and a process for efficiently distributing alert messages through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A computer-implemented method for generating numerical values indicative of risk factors across multiple dimensions in an organization, the method comprising:
generating, by one or more processors, a first hierarchy of auditable entities in an organization using a first parameter and second hierarchy of auditable entities in the same organization using a second parameter, the first hierarchy and the second hierarchy corresponding to a first dimension of the organization and a second dimension of the organization;
receiving, by the one or more processors, an indication of a risk factor and a numerical score for the risk factor;
receiving, by the one or more processors via a user interface, selections of a first auditable entity in the first hierarchy and a second auditable entity in the second hierarchy, with which the risk factor is to be associated; and
automatically calculating, by the one or more processors, respective risk scores for the first auditable entity and the second auditable entity using the received numerical score for the risk factor, in response to the received selections.

2. The computer-implemented method of claim 1, wherein the first dimension is one of:
(i) a legal entities dimension in which the organization is made up of a plurality of legal entities,
(ii) a geographic dimension in which the organization is made up of a plurality of geographic locations,
(iii) an organization process dimension in which the organization is made up of a plurality of organizational processes,
(iv) a business unit dimension in which the organization is made up of a plurality of business units,
(v) an information technology (IT) systems dimension in which the organization is made up of a plurality of IT systems,
(vi) an enterprise risk management risk register dimension, or
(vii) a dimension corresponding to standards set by one or more of a professional association, a committee, and/or a standards body;
and the second dimension is a different one of the dimensions (i)-(vii).

3. The computer-implemented method of claim 1, further comprising automatically calculating a risk score for an auditable entity in a parent relationship with the first auditable entity in the first hierarchy, based on the received risk factor and the numerical score.

4. The computer-implemented method of claim 1, further comprising automatically calculating a risk score for an auditable entity in a parent relationship with the second auditable entity in the second hierarchy, based on the received risk factor and the numerical score.

5. The computer-implemented method of claim 1, wherein the risk factor is a first risk factor, the method further comprising:
receiving, by the one or more processors, an indication of a second risk factor and a numerical score for the second risk factor;
receiving, by the one or more processors via a user interface, a selection of the first auditable entity in the first hierarchy, with which the second risk factor is to be associated and a selection of the second auditable entity in the second hierarchy, with which the second risk factor is not to be associated; and
automatically calculating, by the one or more processors, respective risk scores for the first auditable entity and the second auditable entity using the received numerical scores for the first risk factor and the second risk factor, in response to the received selections.

6. The computer-implemented method of claim 1, wherein the numerical score for the risk factor includes a numerical score for the inherent risk of the risk factor and a numerical score for the residual risk of the risk factor.

7. The computer-implemented method of claim 1, wherein the numerical score for the risk factor is a scaled rating of the risk factor.

8. A computer system for generating numerical values indicative of risk factors across multiple dimensions in an organization, comprising:
one or more processors; and
one or more memories storing instructions that, when executed by the one or more processors, cause the computer system to:
generate a first hierarchy of auditable entities in an organization using a first parameter and second hierarchy of auditable entities in the same organization using a second parameter, the first hierarchy and the second hierarchy corresponding to a first dimension of the organization and a second dimension of the organization;
receive an indication of a risk factor and a numerical score for the risk factor;
receive, via a user interface, selections of a first auditable entity in the first hierarchy and a second auditable entity in the second hierarchy, with which the risk factor is to be associated; and
automatically calculate respective risk scores for the first auditable entity and the second auditable entity using the received numerical score for the risk factor, in response to the received selections.

9. The computer system of claim 8, wherein the first dimension is one of:
(i) a legal entities dimension in which the organization is made up of a plurality of legal entities,
(ii) a geographic dimension in which the organization is made up of a plurality of geographic locations,
(iii) an organization process dimension in which the organization is made up of a plurality of organizational processes,
(iv) a business unit dimension in which the organization is made up of a plurality of business units,
(v) an information technology (IT) systems dimension in which the organization is made up of a plurality of IT systems,
(vi) an enterprise risk management risk register dimension, or
(vii) a dimension corresponding to standards set by one or more of a professional association, a committee, and/or a standards body;
and the second dimension is a different one of the dimensions (i)-(vii).

10. The computer system of claim 8, wherein the instructions further cause the computer system to calculate a risk score for an auditable entity in a parent relationship with the first auditable entity in the first hierarchy, based on the received risk factor and the numerical score.

11. The computer system of claim 8, wherein the instructions further cause the computer system to calculate a risk score for an auditable entity in a parent relationship with the second auditable entity in the second hierarchy, based on the received risk factor and the numerical score.

12. The computer system of claim 8, wherein the risk factor is a first risk factor, and wherein the instructions further cause the computer system to:
receive an indication of a second risk factor and a numerical score for the second risk factor;
receive, via a user interface, a selection of the first auditable entity in the first hierarchy, with which the second risk factor is to be associated and a selection of the second auditable entity in the second hierarchy, with which the second risk factor is not to be associated; and
automatically calculate respective risk scores for the first auditable entity and the second auditable entity using the received numerical scores for the first risk factor and the second risk factor, in response to the received selections.

13. The computer system of claim 8, wherein the numerical score for the risk factor includes a numerical score for the inherent risk of the risk factor and a numerical score for the residual risk of the risk factor.

14. The computer system of claim 8, wherein the numerical score for the risk factor is a scaled rating of the risk factor.

15. A non-transitory computer-readable medium storing instructions for generating numerical values indicative of risk factors across multiple dimensions in an organization that, when executed by one or more processors, cause the one or more processors to:
generate a first hierarchy of auditable entities in an organization using a first parameter and second hierarchy of auditable entities in the same organization using a second parameter, the first hierarchy and the second hierarchy corresponding to a first dimension of the organization and a second dimension of the organization;
receive an indication of a risk factor and a numerical score for the risk factor;
receive, via a user interface, selections of a first auditable entity in the first hierarchy and a second auditable entity in the second hierarchy, with which the risk factor is to be associated; and
automatically calculate respective risk scores for the first auditable entity and the second auditable entity using the received numerical score for the risk factor, in response to the received selections.

16. The non-transitory computer-readable medium of claim 15, wherein the first dimension is one of a (i) a legal entities dimension in which the organization is made up of a plurality of legal entities, (ii) a geographic dimension in which the organization is made up of a plurality of geographic locations, or (iii) an organization process dimension in which the organization is made up of a plurality of organizational processes, and the second dimension is a different one of the dimensions (i)-(iii).

17. The non-transitory computer-readable medium of claim 15, wherein the instructions further cause the one or more processors to calculate a risk score for an auditable entity in a parent relationship with the first auditable entity in the first hierarchy, based on the received risk factor and the numerical score.

18. The non-transitory computer-readable medium of claim 15, wherein the instructions further cause the one or more processors to calculate a risk score for an auditable entity in a parent relationship with the second auditable entity in the second hierarchy, based on the received risk factor and the numerical score.

19. The non-transitory computer-readable medium of claim 15, wherein the risk factor is a first risk factor, and wherein the instructions further cause the one or more processors to:
receive an indication of a second risk factor and a numerical score for the second risk factor;
receive, via a user interface, a selection of the first auditable entity in the first hierarchy, with which the second risk factor is to be associated and a selection of the second auditable entity in the second hierarchy, with which the second risk factor is not to be associated; and
automatically calculate respective risk scores for the first auditable entity and the second auditable entity using the received numerical scores for the first risk factor and the second risk factor, in response to the received selections.

20. The non-transitory computer-readable medium of claim 15, wherein the numerical score for the risk factor includes a numerical score for the inherent risk of the risk factor and a numerical score for the residual risk of the risk factor.
